(19) United States
(12) Patent Application Publication
(10) Pub. No.: US 2013/0144618 A1
(43) Pub. Date: Jun. 6, 2013

(54) METHODS AND ELECTRONIC DEVICES FOR SPEECH RECOGNITION

(71) Applicants: Liang-Che Sun, Taipei (TW); Yiou-Wen Cheng, Hsinchu City (TW); Chao-Ling Hsu, Hsinchu City (TW); Jyh-Horng Lin, Hsinchu City (TW)

(72) Inventors: Liang-Che Sun, Taipei (TW); Yiou-Wen Cheng, Hsinchu City (TW); Chao-Ling Hsu, Hsinchu City (TW); Jyh-Horng Lin, Hsinchu City (TW)

(21) Appl. No.: 13/417,343

(22) Filed: Mar. 12, 2012

Related U.S. Application Data
(60) Provisional application No. 61/566,224, filed on Dec. 2, 2011.

(51) Int. Cl. G10L 15/06; G10L 15/20

(52) U.S. Cl. 704/233; 704/243; 704/E15.007; 704/E15.039

(57) ABSTRACT

A disclosed embodiment provides a speech recognition method to be performed by an electronic device. The method includes: collecting user-specific information that is specific to a user through the user's usage of the electronic device; recording an utterance made by the user; letting a remote server generate a remote speech recognition result for the recorded utterance; generating rescoring information for the recorded utterance based on the collected user-specific information; and letting the remote speech recognition result rescored based on the rescoring information.

### CROSS REFERENCE TO RELATED APPLICATIONS

This application claims the benefit of U.S. provisional application No. 61/566,224, filed on Dec. 2, 2011 and incorporated herein by reference.

### BACKGROUND

1. Technical Field

The invention relates generally to speech recognition, and more particularly, to methods and electronic devices for speech recognition.

2. Related Art

Lacking sufficient computing power to handle complicated tasks is a common problem faced by many consumer electronic devices, such as smart televisions, tablet computers, smart phones, etc. Fortunately, this inherent limitation has been gradually relieved by the concept of cloud computation. Specifically, this concept allows consumer electronic devices to work as clients and delegate complicated tasks to remote servers in the cloud. For example, speech recognition is such a delegable task.

However, most language models used by the remote servers are designed for average users. The remote servers could not or seldom optimize the language models for each individual user. Without customized optimization for each individual user, the consumer electronic devices may be incapable of providing the most accurate and reliable speech recognition services to their users.

### SUMMARY

A disclosed embodiment provides a speech recognition method to be performed by an electronic device. The method includes: collecting user-specific information that is specific to a user through the user's usage of the electronic device; recording an utterance made by the user; letting a remote server generate a remote speech recognition result for the recorded utterance; generating rescoring information for the recorded utterance based on the collected user-specific information; and letting the remote speech recognition result rescored based on the rescoring information.

Another disclosed embodiment provides a speech recognition method to be performed by an electronic device. The method includes: recording an utterance made by a user; extracting noise information from the recorded utterance; letting a remote server generate a remote speech recognition result for the recorded utterance; and letting the remote speech recognition result rescored based on the extracted noise information.

Still another disclosed embodiment provides an electronic device for speech recognition. The electronic device includes an information collector, a voice recorder, and a rescoring information generator. The information collector is operative to collect user-specific information that is specific to a user through the user's usage of the electronic device. The voice recorder is operative to record an utterance made by the user. The rescoring information generator is coupled to the information collector and is operative to generate rescoring information for the recorded utterance based on the collected user-specific information. In addition, the electronic device is operative to let a remote server generate a remote speech recognition result for the recorded utterance, and to let the remote speech recognition result rescored based on the rescoring information.

Yet another disclosed embodiment provides an electronic device for speech recognition. The electronic device includes a voice recorder and a noise information extractor. The voice recorder is operative to record an utterance made by a user of the electronic device. The noise information extractor is coupled to the voice recorder and is operative to extract noise information from the recorded utterance. In addition, the electronic device is operative to let a remote server generate a remote speech recognition result for the recorded utterance, and to let the remote speech recognition result rescored based on the extracted noise information.

Other features of the present invention will be apparent from the accompanying drawings and from the detailed description which follows.

### BRIEF DESCRIPTION OF THE DRAWINGS

The invention is fully illustrated by the subsequent detailed description and the accompanying drawings, in which like references indicate similar elements/steps.

FIG. 1, FIG. 2, FIG. 4, FIG. 5, FIG. 7, FIG. 8, FIG. 10, and FIG. 11 show exemplary block diagrams of distributed speech recognition systems according to some embodiments of the invention.

FIG. 3, FIG. 6, FIG. 9, and FIG. 12 show exemplary flowchart of methods performed by the electronic devices shown in FIG. 1, FIG. 2, FIG. 4, FIG. 5, FIG. 7, FIG. 8, FIG. 10, and FIG. 11.

### DETAILED DESCRIPTION

The following detailed description will introduce several embodiments of the invention's distributed speech recognition systems, each of which includes an electronic device and a remote server. The electronic device can be a consumer electronic device such as a smart television, a tablet computer, a smart phone, or any electronic device that can provide a speech recognition service or a speech recognition-based service to its users. The remote server can be located in the cloud and communicate with the electronic device through the Internet.

When it comes to speech recognition, the electronic device and the remote server have different advantages; the embodiments allow each of these devices to make use of its own advantages to facilitate speech recognition. For example, one of the remote server's advantages that it can have superior computing power and can use a complex model to handle speech recognition. On the other hand, one of the electronic device's advantages is that it is closer to the user and the environment in which speech to be recognized is uttered and hence can collect some auxiliary information that can be used to enhance speech recognition. This auxiliary information may not be available to the remote server for any of the following reasons. For example, the auxiliary information may include personal information that is private in nature and hence the electronic device abstains from sharing the personal information with the remote server. The bandwidth limitation and the cloud storage space constraint may also prevent the electronic device from sharing the auxiliary information with the remote server. As a result, the remote server may have no access to some or all of the auxiliary information collected by the electronic device.

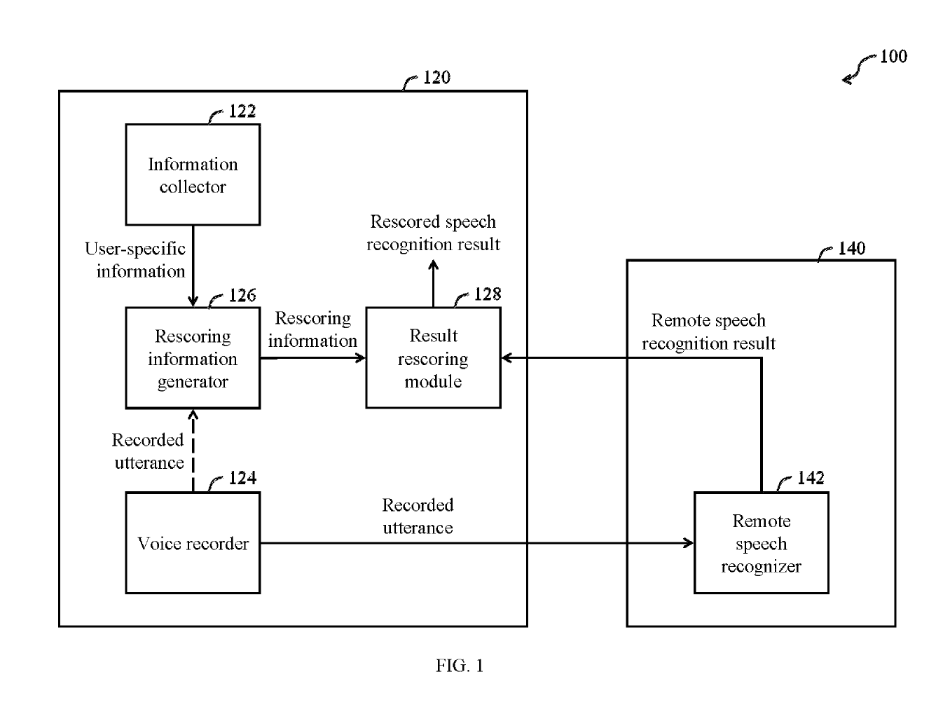

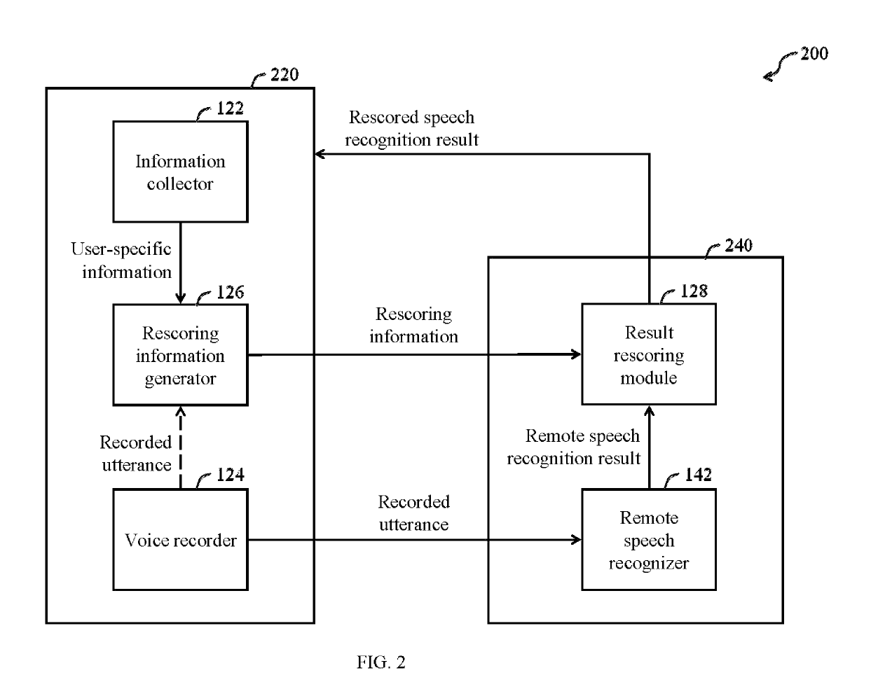

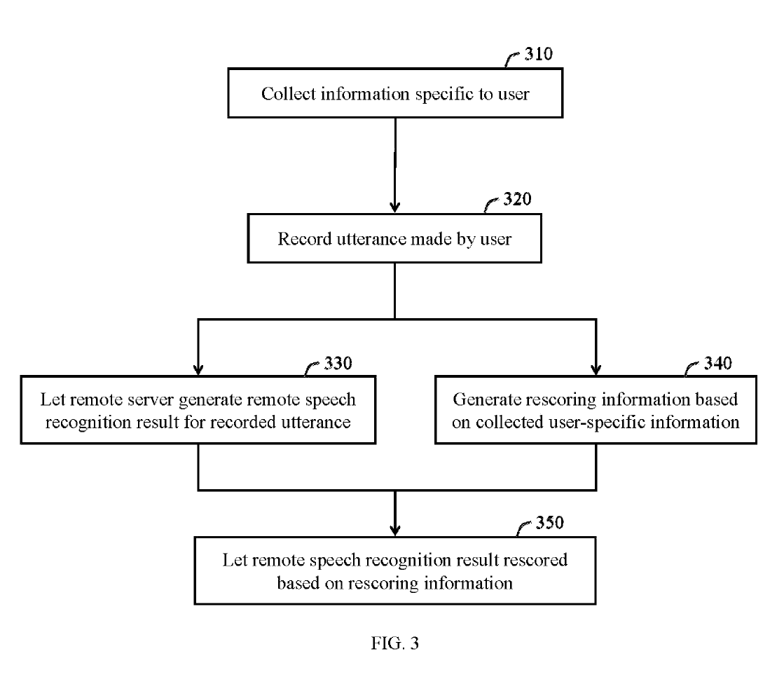

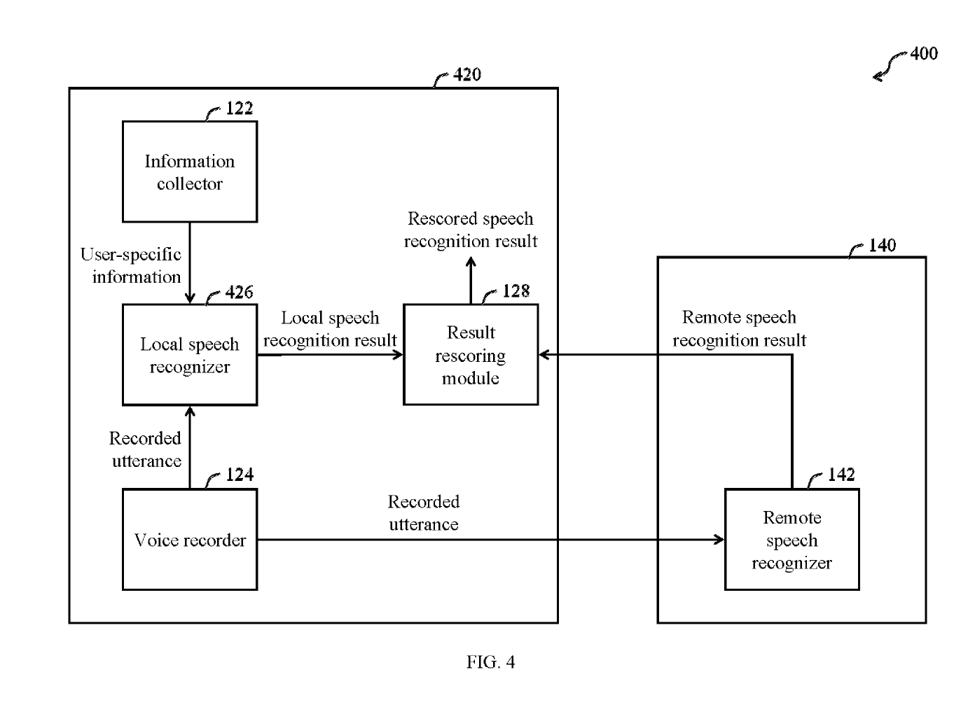

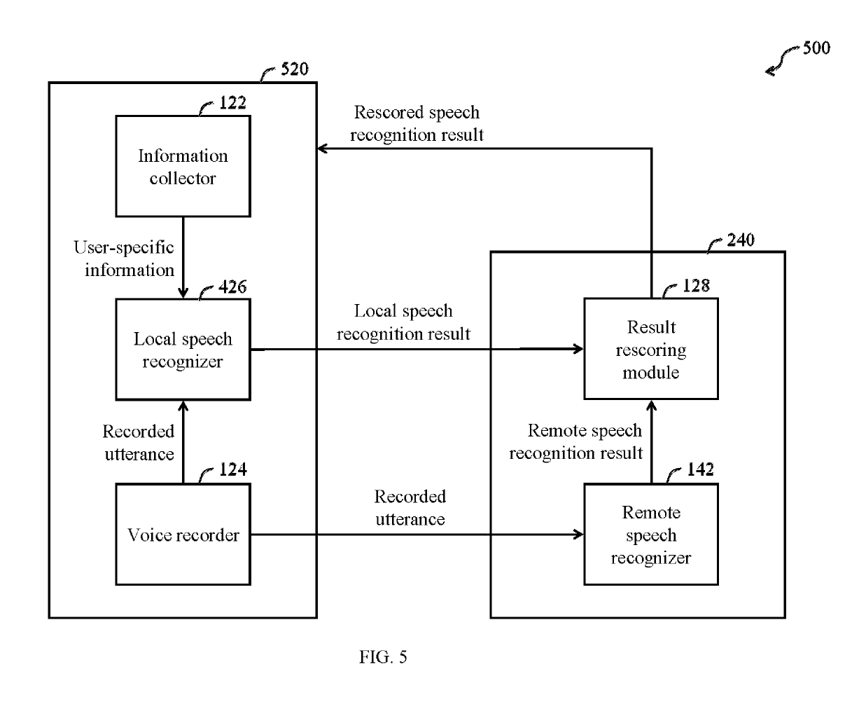

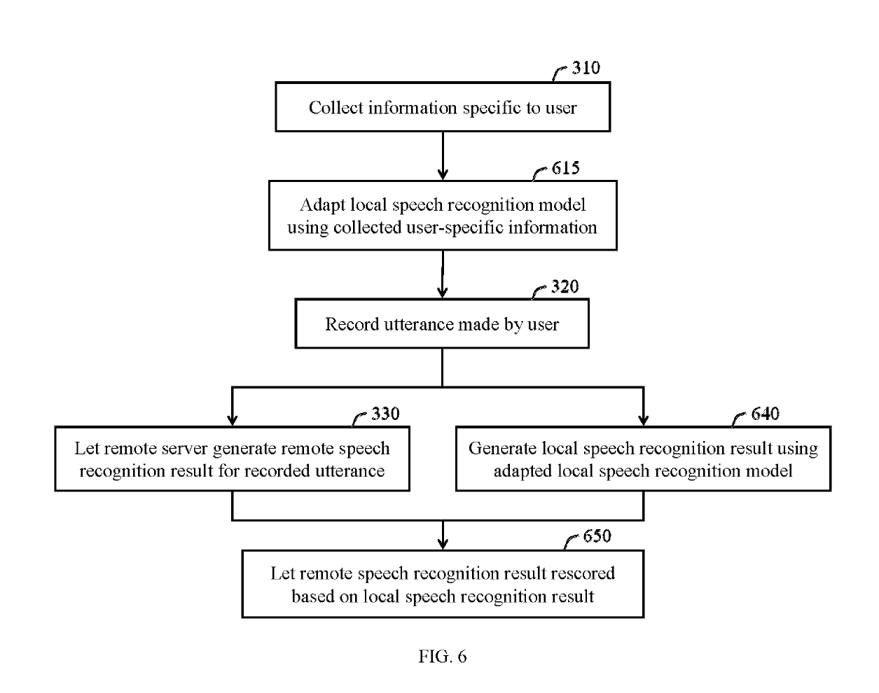

FIG. 1 shows a block diagram of a distributed speech recognition system 100 according to an embodiment of the invention. The distributed speech recognition system 100 includes an electronic device 120 and a remote server 140. The electronic device 120 includes an information collector 122, a voice recorder 124, a rescoring information generator 126, and a result rescoring module 128. The remote server 140 includes a remote speech recognizer 142. FIG. 2 shows a block diagram of a distributed speech recognition system 200 according to another embodiment of the invention. The distributed speech recognition system 200 includes an electronic device 220 and a remote server 240. The embodiments shown in FIG. 1 and FIG. 2 are different in that in FIG. 2, it's the remote server 240, not the electronic device 220, that includes the result rescoring module 128.

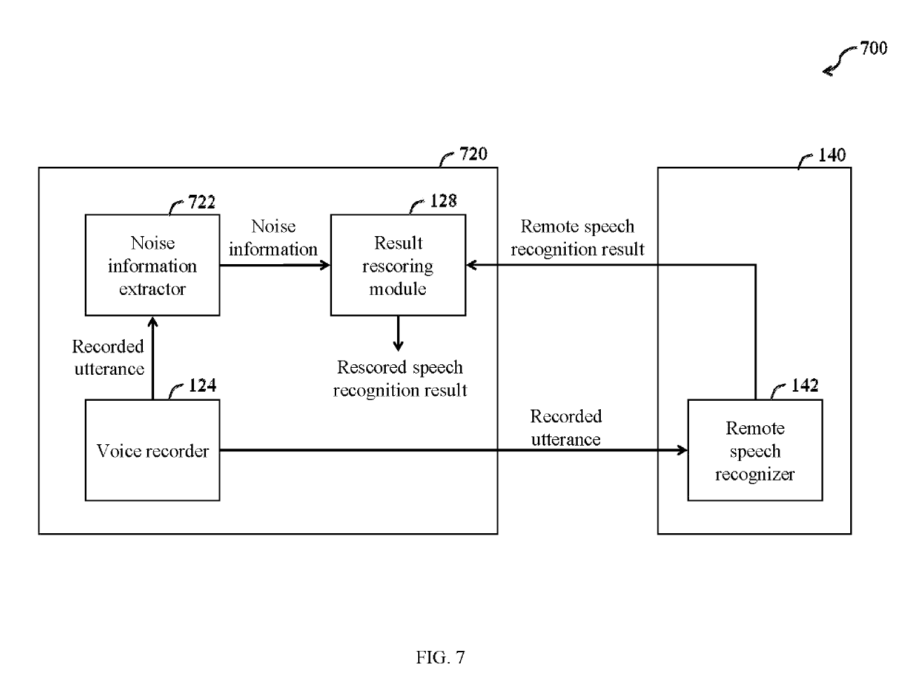

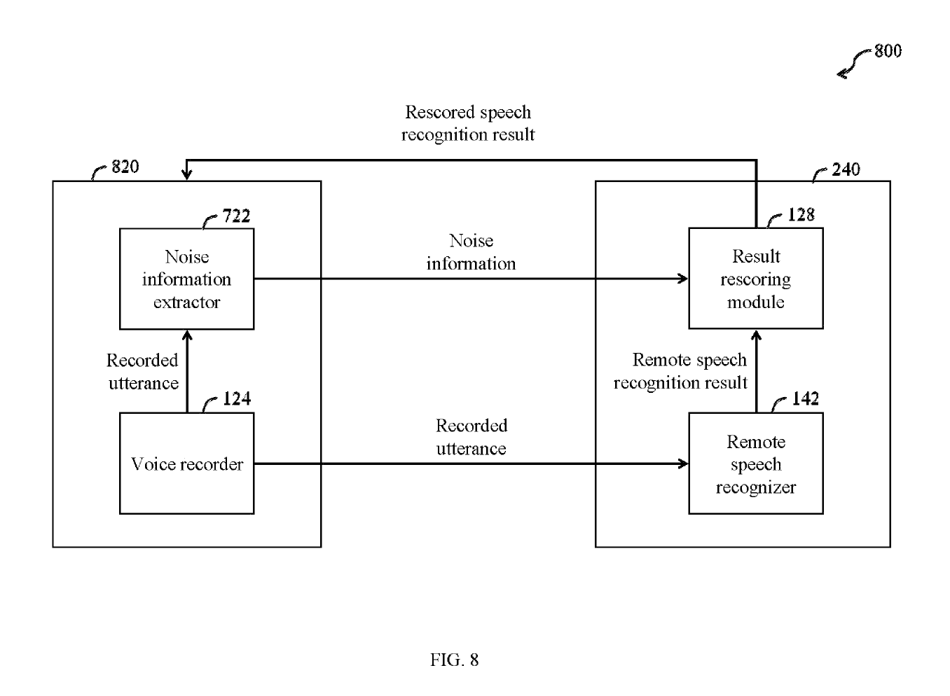

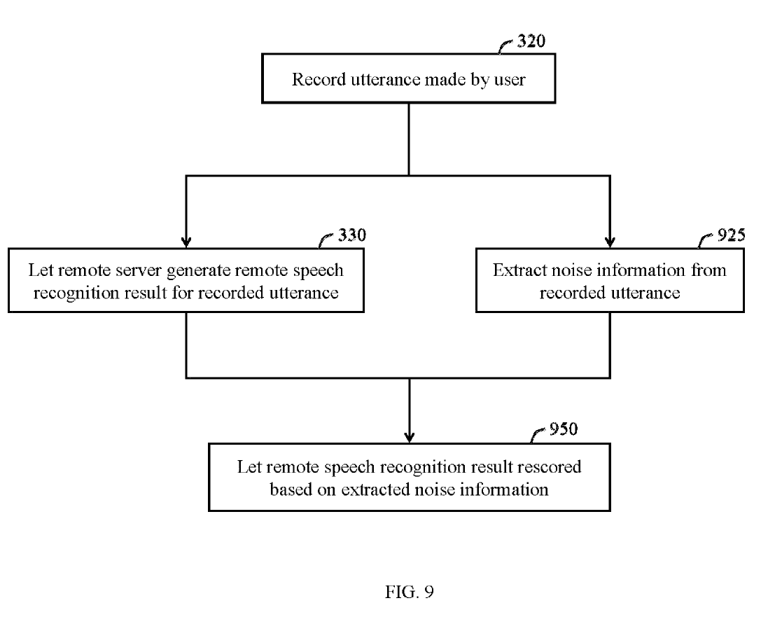

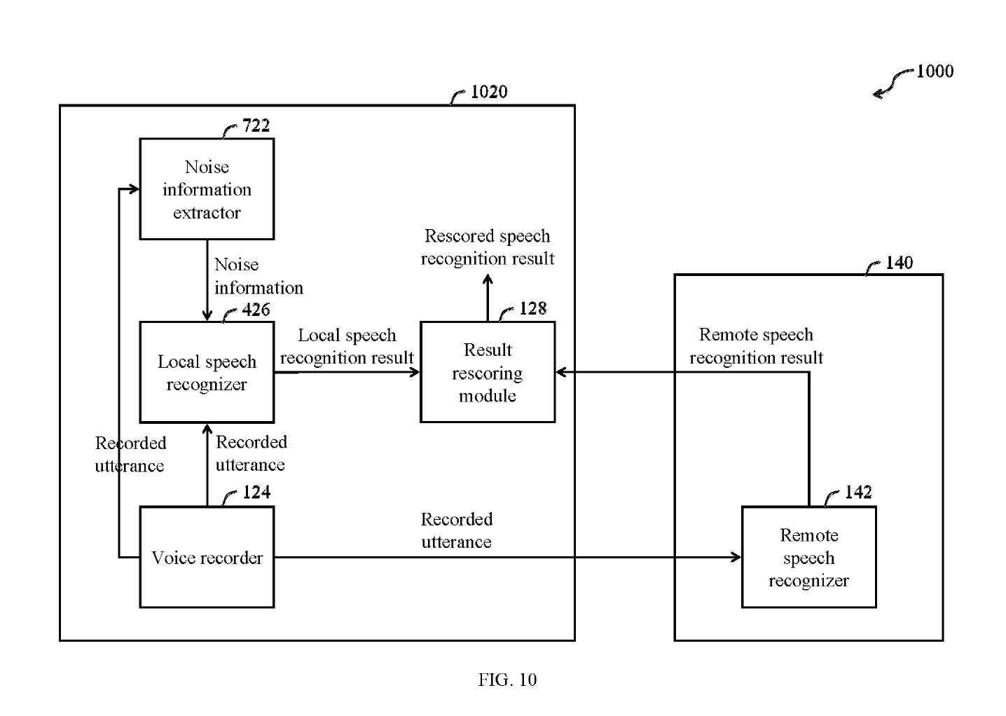

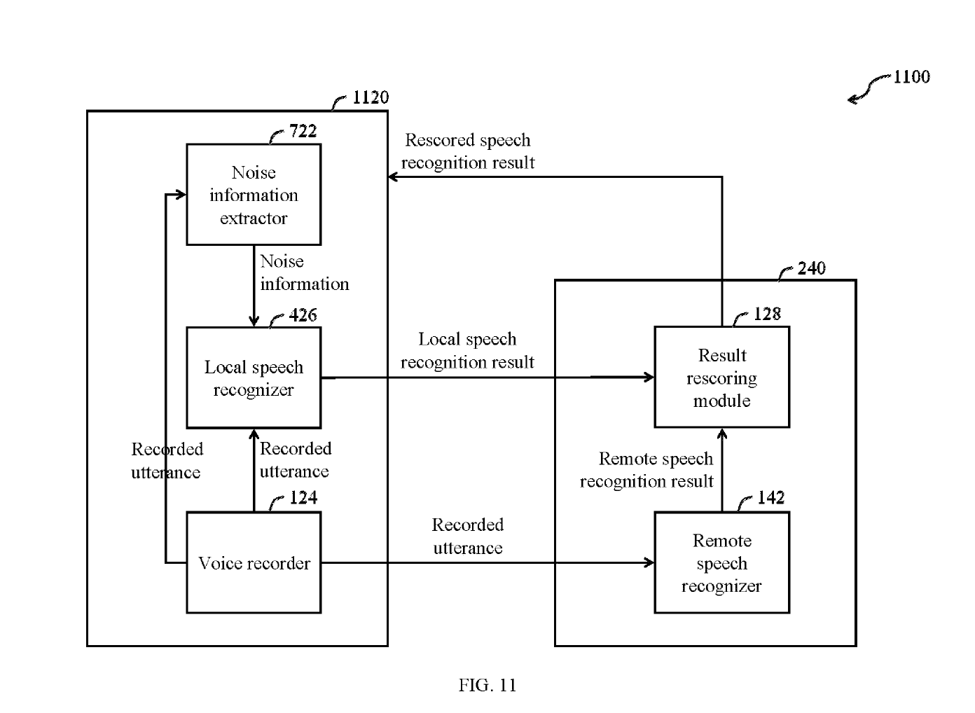

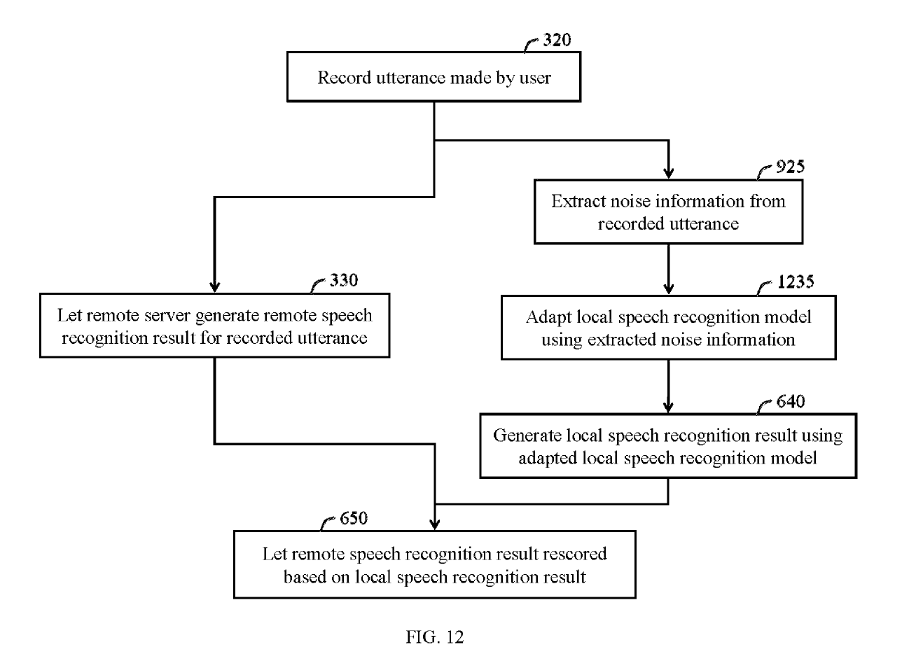

FIG. 3 shows a flowchart of a speech recognition method performed by the electronic device 120/220 of FIG. 1/2. First, at step 310, the information collector 122 collects from a user's usage of the electronic device 120/220 some information specific to the user. The electronic device 120/220 can perform this step when or when not it is connected to the Internet. Exemplary events/occurrences/facts to which the collected user-specific information may pertain include: the user's contact list, some recent events in the user's calendar, some subscribed content/services, some recently made/received/missed phone calls, some recently received/edited/sent messages/emails, some recently visited websites, some recently used application programs, some recently downloaded/accessed e-books/songs/videos, some recent usage of social networking services (such as Facebook, Twitter, Google+, and Weibo), and the user's acoustic characteristics, etc. This user-specific information may reveal the user's personal interests, habits, emotion, frequently used words, etc., and hence may suggest the potential words that the user may use when he/she makes an utterance for the distributed speech recognition system 100/200 to recognize. In other words, the user-specific information may contain valuable information useful for speech recognition.

At step 320, the voice recorder 124 records an utterance made by the user. The user may make the utterance because he/she wants to input a text string to the electronic device 120/220 by way of uttering rather than typing/writing. As another example, the utterance may constitute a command issued by the user to the electronic device 120/220.

At step 330, the electronic device 120/220 lets the remote server 140/240 generate a remote speech recognition result for the recorded utterance. For example, the electronic device 120/220 can do so by sending the recorded utterance or a compressed version of it to the remote server 140/240, waiting for a while, and then receiving the remote speech recognition result back from the remote server 140/240. Because the remote server 140/240 may have superior computing power and use a complex speech recognition model, except for not being optimized for the user, the remote speech recognition result may be quite a good speculation.

The remote speech recognition result may include some successive text units, each of which may include a word or a phrase and be accompanied by a confidence score. The higher the confidence score, the more confident the remote server 140/240 believes that the text unit accompanied by the confidence score is a correct speculation. Each of the text unit may have more than one alternative choices for the user or the electronic device 120/220 to choose from, each accompanied by a confidence score. For example, if the user uttered “the weather today is good” at step 320, the remote server 140/240 may generate the following remote speech recognition result at step 330.

The (5.5) weather (2.3)/whether (2.2) today (4.0) is (3.8) good (3.2)/gold (0.9).

At step 340, the rescoring information generator 126 generates rescoring information for the recorded utterance based on the user-specific information collected at step 310. For example, the rescoring information can include a statistical model of words/phrases that can help the distributed speech recognition system 100/200 to recognize the content of the utterance made at step 320. The rescoring information generator 126 may extract the rescoring information from the collected user-specific information based on a local speech recognition result generated by the electronic device 120/220 for the recorded utterance or the remote speech recognition result generated at step 330. For example, if based on the local/remote speech recognition result the electronic device 120/220 determines that the recorded utterance may include the word “call” or “dial”, the rescoring information generator 126 can provide information related to the user's contact list or recently made/received/missed calls as the rescoring information. The rescoring information generator 126 may also generate the rescoring information without reference to the recorded utterance. For example, as indicated by the collected user-specific information, the rescoring information may include only the words that the user most likely will use.

At step 350, the electronic device 120/220 lets the result rescoring module 128 rescore the remote speech recognition result based on the rescoring information to generate a rescored speech recognition result. As used in the context of speech recognition, the term “rescore” means modify, correct, or try to modify or correct. Because the rescored speech recognition result can be affected by the collected user-specific information, to which the remote server 140/240 may not have access, it's likely that the rescored speech recognition result more accurately represents what the user has uttered at step 320.

For example, if the remote speech recognition result indicates that the remote server 140/240 is uncertain as to whether the recorded utterance include the name “Johnson” or “Jonathan,” and the rescoring information indicates that Johnson is either the contact whose call the user has just missed or the person whom the user plans to meet soon, the result rescoring module 128 may either change the confidence scores associated with “Johnson” and “Jonathan” accordingly or simply exclude “Jonathan” from the rescored speech recognition result.

In FIG. 2, because the result rescoring module 128 is in the remote server 240, at step 350 the electronic device 220 must first send the rescoring information to the remote server 240, wait for a while, and then receive the rescored speech recognition result back from the remote server 240.

The rescoring information generator 126 shown in FIG. 1/2 can be replaced by a local speech recognizer 426; this changes the distributed speech recognition system 100/200 of FIG. 1/2 into a distributed speech recognition system 400/500 of FIG. 4/5. The local speech recognizer 426 can use a local speech recognition model; the local speech recognition model may be simpler than the remote speech recognition model used by the remote speech recognizer 142.

FIG. 6 shows a flowchart of a speech recognition method performed by the electronic device 420/520 of FIG. 4/5. In addition to steps 310, 320, and 330, which have already been explained above, the flowchart of FIG. 6 further includes steps 615, 640, and 650. At step 615, the electronic device 420/520 uses the user-specific information collected by the information collector 122 at step 310 to adapt the local speech recognition model. If the remote server 140/240 can provide its statistical model or some of the user's personal information to the local speech recognizer 426, the local speech recognizer 426 can also use this supplementary information as an additional basis of adaption at step 615. As a result step 615, the adapted local speech recognition model is more user-specific and hence is more suitable for recognizing the utterance made by the specific user at step 320.

At step 640, the local speech recognizer 426 uses the adapted local speech recognition model to generate a local speech recognition result for the recorded utterance. While the recorded utterance received by the remote speech recognizer 142 may be a compressed version, the recorded utterance received by the local speech recognizer 426 may be a raw or uncompressed version. Being able to be used to rescore the remote speech recognition result, the local speech recognition result may also be referred to as “rescoring information,” and the local speech recognizer 426 may also be referred to as a rescoring information generator.

Just like the remote speech recognition result, the local speech recognition result may include some successive text units, each of which may include a word or a phrase and be accompanied by a confidence score. The higher the confidence score, the more confident that the local speech recognizer 426 believes that the text unit accompanied by the confidence score is a correct speculation. Each of the text unit may also have more than one alternative choices, each accompanied by a confidence score.

Although the computing power of the electronic device 420/520 may be inferior to that of the remote server 140/240, and the adapted local speech recognition model may be much simpler than the remote speech recognition model used by the remote speech recognizer 142, the user-specific adaption performed at step 615 makes it possible that the local speech recognition result can sometimes be more accurate than the remote speech recognition result.

At step 650, the electronic device 420/520 lets the result rescoring module 128 rescore the remote speech recognition result based on the local speech recognition result to generate a rescored speech recognition result. Because the rescored speech recognition result can be affected by the collected user-specific information, to which the remote server may not have access, it's possible that the rescored speech recognition result accurately represents what the user has uttered at step 320.

For example, if the remote speech recognition result is “the (5.5) weapon (0.5) today (4.0) is (3.8) good (3.2),” and the local speech recognition result is “the (4.4) weather (2.3) tonight (2.1) is (3.4) good (3.6),” the rescored speech recognition result may be “the weather today is good” and correctly represent what the user has uttered at step 320.

Because the embodiment shown in FIG. 4/5 includes the local speech recognizer 426, the electronic device 420/520 can skip step 650 or both steps 330 and 650 and simply use the local speech recognition result generated at step 640 as the finalized speech recognition result if the remote server 140/240 is down or the network is slow, or if the local speech recognizer 426 has great confidence in the local speech recognition result. This can improve the user's experience in using the speech recognition or speech recognition-based service provided by the electronic device 420/520.

FIG. 7 shows a block diagram of a distributed speech recognition system 700 according to an embodiment of the invention. The speech recognition system 700 includes an electronic device 720 and the remote server 140. The electronic device 720 is different from the electronic device 120 shown in FIG. 1 in that the former includes a noise information extractor 722 but not the information collector 122 nor the rescoring information generator 126. FIG. 8 shows a block diagram of a distributed speech recognition system 800 according to an embodiment of the invention. The speech recognition system 800 includes an electronic device 820 and the remote server 240. The electronic device 820 is different from the electronic device 720 shown in FIG. 7 in that the former does not include the result rescoring module 128.

When it comes to speech recognition, the electronic device 720/820 has some advantages over the remote server 140/240. For example, one of the electronic device 720/820's advantages is that it is closer to the environment in which utterances for speech recognition are made. As a result, the electronic device 720/820 can more easily analyze the noise that accompanies the user's utterances to be recognized. This may be caused by the fact that the electronic device 720/820 has access to the recorded utterances intact but provides only compressed versions of the recorded utterance to the remote server 140/240. It's relatively more difficult for the remote server 140/240 to do noise analysis using the recorded utterance as compressed.

FIG. 9 shows a flowchart of a speech recognition method performed by the electronic device 720/820 of FIG. 7/8. In addition to steps 320 and 330, which have already been explained above, the flowchart of FIG. 9 further includes step 925 and 950. At step 925, the noise information extractor 722 extracts noise information from the recorded utterance. For example, the extracted noise information may include a signal-to-noise ratio (SNR) value that indicates the extent to which the recorded utterance has been tainted by noise.

At step 950, the electronic device 720/820 lets the result rescoring module 128 rescore the remote speech recognition result based on the extracted noise information to generate a rescored speech recognition result.

For example, when the SNR value is low, the result rescoring module 128 can give higher confidence scores on vowels. As another example, when the SNR value is high, the result rescoring module 128 can give higher weight to speech frames. Because the rescored speech recognition result can be affected by the extracted noise information, it's likely that the rescored speech recognition result more accurately represents what the user has uttered at step 320.

In FIG. 8, because the result rescoring module 128 is in the remote server 240, at step 950 the electronic device 820 must send the extracted noise information to the remote server 240, wait for a while, and then receive the rescored speech recognition result back from the remote server 240.

FIG. 10 shows a block diagram of a distributed speech recognition system 1000 according to an embodiment of the invention. The speech recognition system 1000 includes an electronic device 1020 and the remote server 140. The electronic device 1020 is different from the electronic device 420 shown in FIG. 4 in that the former includes the noise information extractor 722 but not the information collector 122. FIG. 11 shows a block diagram of a distributed speech recognition system 1100 according to an embodiment of the invention. The speech recognition system 1100 includes an electronic device 1120 and the remote server 240. The electronic device 1120 is different from the electronic device 520 shown in FIG. 5 in that the former includes the noise information extractor 722 but not the information collector 122.

FIG. 12 shows a flowchart of a speech recognition method performed by the electronic device 1020/1120 of FIG. 10/11. In addition to steps 320, 925, 330, 640, and 650, which have already been explained above, the flowchart of FIG. 12 further includes a step 1235. At step 1235, the electronic device 1020/1120 uses the extracted noise information provided by the noise information extractor 722 to adapt the local speech recognition model used by the local speech recognizer 426. For example, if the extracted noise information indicates that the recorded utterance includes much noise, the adapted local speech recognition model can be one that is more suitable for noisy environment; if the extracted noise information indicates that the recorded utterance is relatively noise-free, the adapted local speech recognition model can be one that is more suitable for quiet environment.

Although the adapted local speech recognition model may be much simpler than the remote speech recognition model used by the remote speech recognizer 142, the noise-based adaption performed at step 1235 makes it possible that the local speech recognition result generated by the local speech recognizer 426 at step 640 can sometimes be more accurate than the remote speech recognition result.

Because the embodiment shown in FIG. 10/11 includes the local speech recognizer 426, the electronic device 1020/1120 can skip step 650 or both steps 330 and 650 and simply uses the local speech recognition result generated at step 640 as the finalized speech recognition result if the remote server 140/240 is down or the network is slow, or if the local speech recognizer 426 has great confidence in the local speech recognition result. This can improve the user's experience in using the speech recognition or speech recognition-based service provided by the electronic device 1020/1120.

In the aforementioned embodiments, the electronic device 120/220/420/520/720/820/1020/1120 can make use of the rescored speech recognition result provided by the result rescoring module 128 at step 350/650/950. To name a few examples, the electronic device 120/220/420/520/720/820/1020/1120 can display the rescored speech recognition result on a screen, call a phone number associated with a name contained in the result, add the result into an edited file, start or control an application program in response to the result, or perform a web search using the result as a search query.

In the foregoing detailed description, the invention has been described with reference to specific exemplary embodiments thereof. It will be evident that various modifications may be made thereto without departing from the spirit and scope of the invention as set forth in the following claims. The detailed description and drawings are, accordingly, to be regarded in an illustrative sense rather than a restrictive sense.

What is claimed is:

1. A speech recognition method performed by an electronic device, comprising:
collecting user-specific information that is specific to a user through the user's usage of the electronic device;
recording an utterance made by the user;
letting a remote server generate a remote speech recognition result for the recorded utterance;
generating rescoring information for the recorded utterance based on the collected user-specific information; and
letting the remote speech recognition result rescored based on the rescoring information.

2. The method of claim 1, wherein the rescoring information comprises a local speech recognition result, and the step of generating the rescoring information comprises:
adapting a local speech recognition model based on the collected user-specific information; and
generating the local speech recognition result for the recorded utterance using the adapted local speech recognition model.

3. The method of claim 1, further comprising
abstaining from sharing at least a part of the collected user-specific information with the remote server.

4. The method of claim 1, wherein the collected user-specific information comprises information that the remote server has no access to.

5. A speech recognition method performed by an electronic device, comprising:
recording an utterance made by a user;
extracting noise information from the recorded utterance;
letting a remote server generate a remote speech recognition result for the recorded utterance; and
letting the remote speech recognition result rescored based on the extracted noise information.

6. The method of claim 5, wherein the step of letting the remote speech recognition result rescored comprises:
adapting a local speech recognition model using the extracted noise information;
generating a local speech recognition result for the recorded utterance using the adapted local speech recognition model; and
letting the remote speech recognition result rescored based on the local speech recognition result.

7. The method of claim 5, wherein the extracted noise information comprises a signal-to-noise ratio (SNR).

8. An electronic device for speech recognition, comprising:
an information collector, operative to collect user-specific information that is specific to a user through the user's usage of the electronic device;
a voice recorder, operative to record an utterance made by the user; and
a rescoring information generator, coupled to the information collector and operative to generate rescoring information for the recorded utterance based on the collected user-specific information;
wherein the electronic device is operative to:
let a remote server generate a remote speech recognition result for the recorded utterance; and
let the remote speech recognition result rescored based on the rescoring information.

9. The electronic device of claim 8, wherein the rescoring information comprises a local speech recognition result, and the rescoring information generator uses a local speech recognition model and is operative to:
adapt the local speech recognition model using the collected user-specific information; and
generate the local speech recognition result for the recorded utterance using the adapted local speech recognition model.

10. The electronic device of claim 8, wherein the collected user-specific information comprises information that the electronic device abstains from sharing with the remote server.

11. The electronic device of claim 8, wherein the collected user-specific information comprises information that the remote server has no access to.

12. An electronic device for speech recognition, comprising:
a voice recorder, operative to record an utterance made by a user of the electronic device; and
a noise information extractor, coupled to the voice recorder and operative to extract noise information from the recorded utterance;
wherein the electronic device is operative to:
let a remote server generate a remote speech recognition result for the recorded utterance; and
let the remote speech recognition result rescored based on the extracted noise information.

13. The electronic device of claim 12, wherein the electronic device further comprises a local speech recognizer that is coupled to the voice recorder and the noise information extractor, has a local speech recognition model, and is operative to adapt the local speech recognition model based on the extracted noise information and to generate a local speech recognition result for the recorded utterance using the adapted local speech recognition model, and the electronic device is operative to let the remote speech recognition result rescored based on the local speech recognition result.

14. The electronic device of claim 12, wherein the extracted noise information comprises a signal-to-noise ratio (SNR).
